(19) United States
(12) Patent Application Publication
(10) Pub. No.: US 2002/0084612 A1
(43) Pub. Date: Jul. 4, 2002

(54) Scooter brake system

(76) Inventor: Kui-Wong Yeung, Kwai Chung N.T. (HK)

Correspondence Address: JACOBSON, PRICE, HOLMAN & STERN, PROFESSIONAL LIMITED LIABILITY COMPANY, 400 SEVENTH STREET, N.W., WASHINGTON, DC, 20004, US

(21) Appl. No.: 09/751,308

(22) Filed: Jan. 2, 2001

(51) Int. Cl. B62M 1/00

(52) U.S. Cl. 280/87.041; 280/152.1; 188/19

(57) ABSTRACT

This invention provides a scooter and a braking system for a scooter applied to the back or rear wheel of the scooter. A pivotally mounted mudguard may be attached to a drive lever to drive a brake pad into contact with the outer perimeter of the rear wheel. In an alternative embodiment the brake pad is pivotally mounted with respect to a fixed mudguard with a portion in the form of a brake pad or similar being a depressible portion protruding through or around the mudguard for access by the user.

### FIELD OF THE INVENTION

This invention relates to a scooter brake system and, in particular, a brake system for a two-wheeled non-motorized scooter. It should be appreciated that such brake systems may be applicable to motorized scooters or skate bikes or similar including those having a greater number of wheels.

### DESCRIPTION OF THE PRIOR ART

Scooters, generally in the form of a two-wheeled vehicle having a board to stand upon and a steering mechanism and handle from a front wheel have been available for numerous years

In more recent times, such scooters have again become popular especially when formed in a manner to fold tip compactly to make storage and transporting easier

A recent example of such a scooter is shown in U.S. Pat. No. 5,927,733. This device provides a brake to the conventional scooter, Generally the conventional scooter were made for children to use in relatively flat areas and not at great speeds such that brakes seemed unnecessary. With the improvements in the scooters themselves and their popularity with older age groups as a mode of transportation, some form of braking has become desirable.

The braking system described in U.S. Pat. No. 5,927,733 utilizes a pivotally mounted mudguard over the rear wheel to act as the brake pedal. A user can apply pressure to the mudguard and braking is activated upon the pivotal movement of the mudguard. Typically, the pressure would be applied by a user shifting a rear foot onto the mudguard to apply the pressure.

The device described to provide the braking uses dual activated brake pads acting on sides of the wheels and clamping the wheel in a similar fashion to brake systems provided on bicycles. Such a mechanism is relatively complex to manufacture, expensive and liable to breakage or wear.

A subsequent system is described in U.S. Pat. No. 6,139,035. In the device described in that US patent, a simpler system is provided that again utilizes the rear mudguard as the brake pedal. The rear mudguard is pivoted at a front end of the mudguard and rather than utilizing a brake pad acting on the side of the wheel uses an inner lining of the mudguard to act directly on the wheel itself Although simpler, such a device may be more awkward for a user as the user needs to stand further back on the mudguard to apply pressure. This is due to the front-end pivot and the need for the user to apply pressure behind that pivot to have any effect Furthermore, the braking provided by such a liner may not be as easy to maintain as one that has a separable brake pad. This device may also cause greater stresses on the pivot mechanism and the mudguard as a whole as the user increases pressure directly on the mudguard to press down on the wheel.

### OBJECT OF THE INVENTION

It is an object of the present invention to provide a scooter braking system and a scooter having such a system that overcomes some of the disadvantages of the prior art or at least provides the public with a useful choice.

### SUMMARY OF THE INVENTION

Accordingly, in a first aspect, the invention may broadly be said to consist in a scooter brake system including:

a rear mudguard attached to the frame of said scooter;

a rear wheel rotationally mounted to the frame of said scooter;

a brake surface adjacent a rim of said rear wheel;

a depressible portion within or about said rear mudguard for depression by a user to drive said brake surface into contact with said rear wheel; and

biasing means to bias said depressible portion and said brake surface to a non-braking position.

Accordingly, in a second aspect, the invention may broadly be said to consist in a scooter including:

a frame or board on which a user may stand;

a front wheel rotationally mounted to said frame;

a rear wheel rotationally mounted to said frame;

a rear mudguard pivotally mounted to said same at one end thereof;

a brake drive lever attached to said rear mudguard and movable when said rear mudguard is pivoted under pressure from a user;

a brake pad attached to said drive lever and adjacent a rim of said rear wheel and engageable with said rim of said wheel upon being driven by said lever; and

biasing means to bias said mudguard, drive lever and brake pad to a non-braking position.

### BRIEF DESCRIPTION OF THE DRAWINGS

Preferred embodiments of the invention will now be described with reference to the following drawings in which:

FIG. 1 shows an elevational view of a embodiment of the invention;

FIG. 2 shows a cross-sectional elevational view through the rear wheel and braking system of the embodiment of FIG. 1 when in a first position;

FIG. 3 is a cross-sectional elevational view of the apparatus of FIG. 2 in a second position;

FIG. 4 is a cross-sectional elevational view of a second embodiment of a braking system when in a first position;

FIG. 5 is a cross-sectional elevational view through the apparatus of FIG. 4 in a second position;

FIG. 6 is a cross-sectional elevational view through a braking system in accordance with a third embodiment of the invention when in a first position;

FIG. 7 is a cross-sectional elevational view through the apparatus of FIG. 6 when in a second position; and

FIG. 8 is a further cross-sectional elevational view through the apparatus of FIG. 6 when in the first position.

### DETAILED DESCRIPTION OF PREFERRED EMBODIMENTS

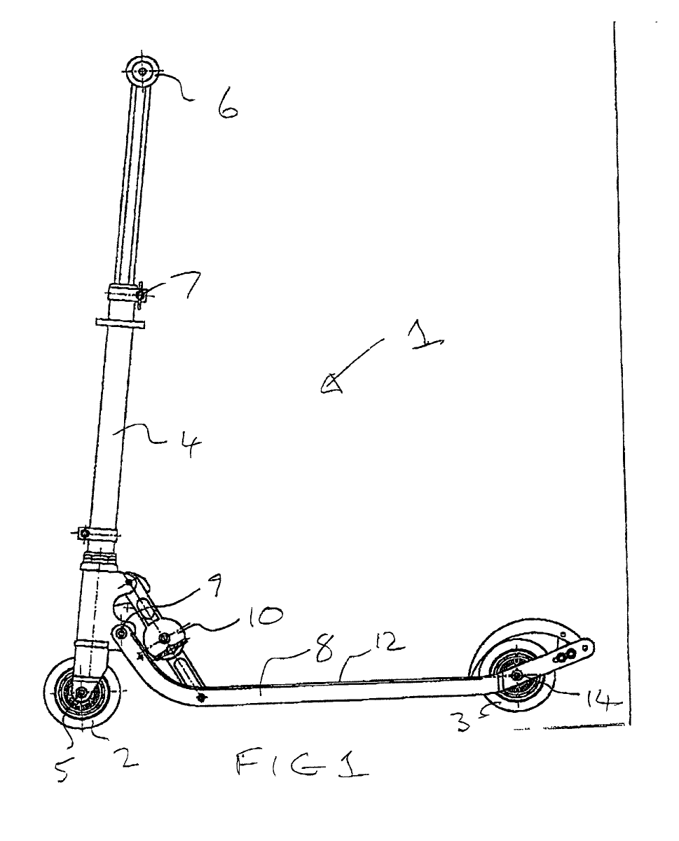

Referring to FIG. 1, a scooter 1 is shown in the general form of the more recent collapsible scooters. As shown, the scooter 1 has a front wheel 2 and a rear wheel 3. It should be appreciated that although the invention as described refers to such a configuration, other configurations that incorporate dual front or rear wheels to form a three or four-wheeled motorized or non-motorized vehicle may also be envisaged.

In accordance with this generally conventional configuration of a scooter, the front wheel 2 is connected to a steering column 4 and rotationally mounted by an axle 5. An extendable handle 6 is provided to steer the scooter and, through the release mechanism 7, can telescope into the column 4 to provide a more compact at during transportation.

Similarly, the column 4, front wheel 2 and handle 6 are pivotally attached to the main fame 8 by the pivotal mounting 9. This is locked by a locking mechanism 10 into the configuration as shown for use although release of the locking mechanism 10 allows the column 4 to rotate to a position substantially parallel to the main fame 8 to form a compact structure.

Again, although this collapsible feature of these embodiments is described, the invention itself could be applied to more conventional scooters without such adaptations.

The main frame 8 supports a board 12 on which a user may stand. Although the board 12 and frame 8 are generally described as separate items, they could be formed in a unitary construction as an integral item in a variety of different forms.

The rear wheel 3 is itself rotationally mounted by an axle 14 to a rear portion of the frame 8. This rear portion of the frame 8 will normally be configured into a pair of rear forks with the rear wheel 3 nested between the forks. Again, other configurations are possible.

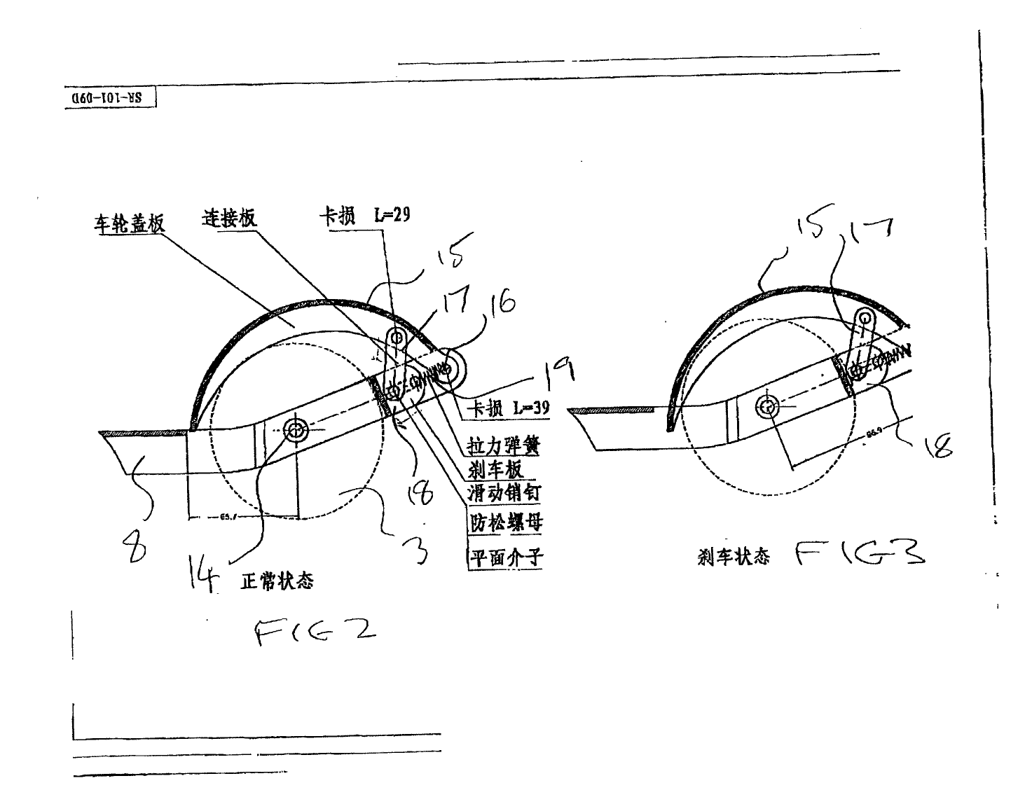

Referring to FIG. 2, a braking system can be seen as applied on the rear wheel 3 of the scoter.

The braking system provides a rear mudguard 15 that is typically mounted to the frame 8 at one end of the, mudguard 15. As shown in this particular embodiment, the pivotal mounting 16 is at the rear end of the mudguard 15.

Attached to the mudguard 15 is a drive lever 17 that is attached to the mudguard at one end and to a brae pad 18 at the other end. For stability, the brake pad 18, is sliding engaging with the frame 8 and movable between a braking and a non-braking position as shown in FIGS. 3 and 2 respectively.

It can be seen that the drive lever 17 is pivotally mounted to both the mudguard 15 and to the brake pad 18 and arranged such that the pivotal connection to the mudguard 15 is further away from the wheel 3 that the pivotal connection to the braking pad 18. With such an arrangement, as the mudguard 15 is rotated about the pivot 16 in a downwards direction as shown in FIG. 2, the drive lever 17 pushes the brake pad into contact with the outer rim or perimeter of the wheel 3. The position once the brake is applied is show in FIG. 3.

It should be appreciated that the brake pad 18 does not need to be stabilized by a sliding connection with the fame 8 if an alternative connection such as suspension from the mudguard 15 can be employed. The embodiment shows only one preferred arrangement of positioning the brake pad 18 so that it may receive pressure directly from a drive lever 17 connected to the mudguard 15.

The brake pad 18 is positioned to bear directly on the outer perimeter of the wheel 3 rather than engage a side of the wheel 3. This may provide more effective braking than clamping the wheel 3 in the conventional fashion.

As shown in FIG. 3, it can also be seen that the front end of the mudguard 15 is the end on which a user can easily stand to apply the brakes. By configuring the braking system in such a manner, the user is able to make maximum use of the lever provided by the mudguard 15 with minimum movement of the foot. Rather than having to reach the back of the mudguard 15 to apply the greatest pressure, it is the closest end of the mudguard 15 to the user that applies the maximum force to the brake itself.

To return the brake to the non-braking position, a biasing means 19 may be employed. In the embodiment shown, the biasing means 19 comprises a coil or spring between the brake pad 18 and the pivotal connection 16 on which the mudguard 15 is mounted. It will be appreciated that the spring 19 cam be provided by other forms of spring and also attached to various points on either the mudguard 15 or the frame 8 to return the brake pad 18 to its original position. Indeed, the biasing means 19 can act on the drive lever 17 by connection to the lever 17 and either the mudguard 15 or the frame 8 rather than acting on the brake pad 18 as shown.

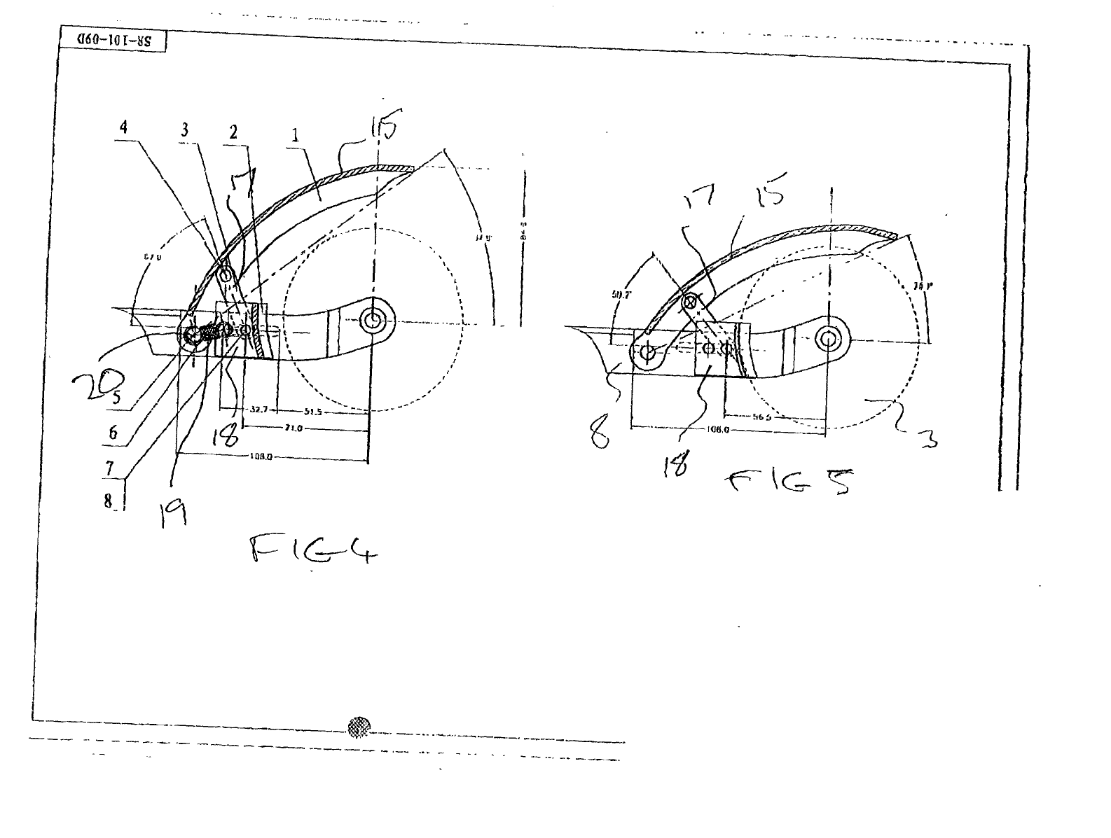

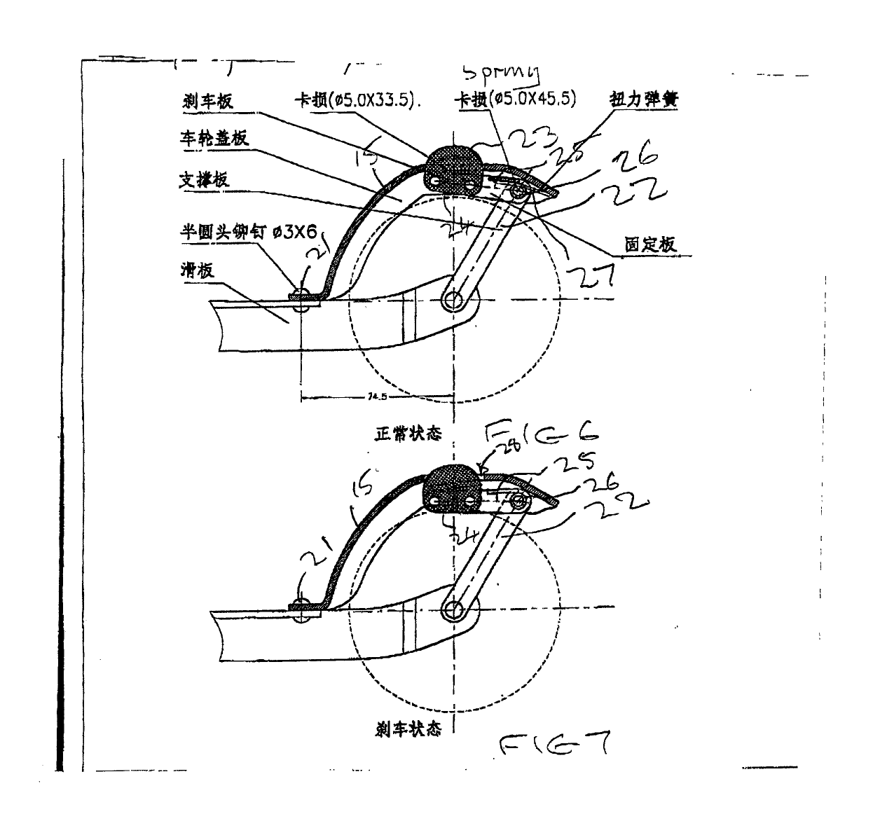

A further embodiment of the invention is shown in FIGS. 4 and 5. If it is desired to provide a scooter having a shorter frame 8 for smaller packaging or easier transportation, the mudguard 15 can be pivotally connected about its front end with a pivotal connection 20 to the frame 8. As shown in FIG. 4, the brake system and assembly comprising the drive lever 17, brake pad 18 and biasing means 19 is placed between the mudguard and the wheel 3 at the front end of the wheel 3. Such an arrangement shortens the extension of the fire 8 behind the rear edge of the wheel 3 but does require a user to place greater pressure towards the rear end of the mudguard 15 to provide the greatest braking.

The arrangement as shown it FIG. 4 is shown in the braking position in FIG. 5 where the mudguard 15 has rotated about the pivotal mounting 20 so that the drive lever 17 has forced the brake pad 18 into contact with the outer perimeter of the wheel 3.

In a further embodiment (not shown), the rear mudguard 15 can be pivotally connected about its rear end in the manner as shown in FIG. 3. However, it is still possible to mount the brake pad 18 and drive lever 17 attached adjacent the front edge of the mudguard 15 as shown in FIGS. 4 and 5. This may reduce the amount by which the frame 8 needs to extend past the rear wheel 3 while still providing the mudguard 15 pivoted about its rear end such that the user obtains ma um leverage from applying pressure at the front end of the mudguard 15.

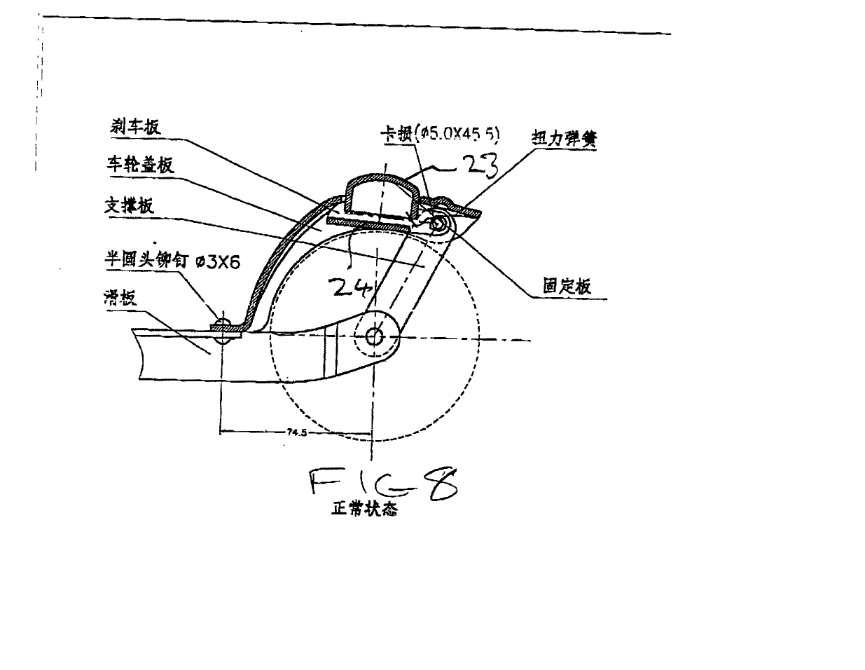

A yet further embodiment of he invention is shown in FIGS. 6 and 7. In this embodiment, the rear mudguard 15 is substantially fed in position by a fixed connection 21 and a supporting rod 22 supporting the distal end of the mudguard 15. The supporting rod 22 may not necessarily be required if there is sufficient stiffness in the mudguard 15 to be self-supporting.

As shown in this embodiment, a depressible portion 23 extends through or around the mudguard 15 so that it may be accessed by a user and pressure may be applied directly to the portion 23. The portion 23 is itself attached to a brake surface 24 that will act directly on the outer rim of the wheel 3 to provide the braking.

Although a number of embodiments are possible to provide such an arrangement, this preferred embodiment supports the depressible portion 23 and the brake surface 24 on a support member 25 that is itself pivotally connected to the mudguard 15, For convenience, it is pivotally mounted at the same point of correction as the support rod 22 although this is by no means essential. It is pivotally mounted at a distal point on the mudguard to provide almost linear travel to the portion 23 and brake pad 24 through the small movement necessary to engage the wheel.

A biasing means 27 is also employed to return the depressible portion 23 and brake surface 24 to the non-braking system as show in FIG. 6. The biasing means in this instance may be a simple leaf or coil spring 27 acting about the pivot 26. Any other form of spring or bias can be used if desired.

In this particular embodiment it can be seen that the depressible portion 23 acts through an aperture 28 in the mudguard 15. In an alternative arrangement, the depressible portion 23 may extend over the mudguard 15 can be raised above the mudguard 15 and attached through a cantilever portion around the side of the mudguard 15 to the brake surface 24 underneath A variety of forms of connection between the depressible portion 23 and the brake surface 24 are possible including the provision of a single unitary item.

Referring to FIG. 8, it can be seen that the depressible portion 23 and the brake surface 24 are engaged together but separate items, This is not strictly necessary as mentioned previously.

Thus it can be seen that a variety of brake systems are provided that provide some advantages over the prior art in the form of simplicity and the provision of a braking system that applies a separate brake pad directly to an outer perimeter of the wheel 3.

Although this invention has been described with reference to these particular embodiments and specific integers in the embodiments, the scope of the invention is not limited by that description but instead by the appended clans, Specific integers referred to throughout the description are deemed to incorporate known equivalence where appropriate.

1. A scooter brake system including:
a rear mudguard attached to the frame of said scooter;
a rear wheel rotationally mounted to the frame of said scooter;
a brake surface adjacent a rim of said rear wheel;
a depressible portion within or about said rear mudguard for depression by a user to drive said brake surface into contact with said rear wheel; and
biasing means to bias said depressible portion and said brake surface to a non-braking position.

2. A scooter brake system as claimed in claim 1 wherein said depressible portion protrudes through said mudguard to a position above an upper surface of said mudguard for access by a user.

3. A scooter brake system as claimed in claim 1 wherein sad depressible portion and said brake surface are pivotally mounted to a distal point of said mudguard.

4. A scooter brake system as claimed in claim 1 wherein said brae surface is attached to or provided by an underside of said depressible portion.

5. A scooter including:
a frame or board on which a user may stand;
a front wheel rotationally mounted to said fame;
a rear wheel rotationally mounted to said frame;
a rear mudguard pivotally mounted to said frame at one end thereof;
a brake drive lever attached to said rear mudguard and movable when said rear mudguard is pivoted under pressure from a user;
a brake pad attached to said drive lever and adjacent a rim of said rear wheel and engageable with said rim of said wheel upon being driven by said lever; and
biasing means to bias said mudguard; drive lever and brake pad to a non-braking position.

6. A scooter as claimed in claim 5 wherein said drive lever is pivotally mounted to said mudguard and, at a distal end, to said brake pad.

7. A scooter as claimed in claim 5 wherein said brake pad is sliding engaged to said frame.

8. A scooter as claimed in claim 5 wherein said biasing means is provided in the form of a spring.
